(19) United States
(12) Patent Application Publication
(10) Pub. No.: US 2006/0190936 A1
(43) Pub. Date: Aug. 24, 2006

(54) Just-in-time kilo virtual machine system

(75) Inventor: Yueh-Wei Hu, Taipei City (TW)

Correspondence Address: BACON & THOMAS, PLLC, 625 SLATERS LANE, FOURTH FLOOR, ALEXANDRIA, VA, 22314, US

(73) Assignee: Institute for Information Industry, Taipei City (TW)

(21) Appl. No.: 11/118,365

(22) Filed: May 2, 2005

(30) Foreign Application Priority Data
Feb. 23, 2005 (TW) 094105418

(51) Int. Cl. G06F 9/45

(52) U.S. Cl. 717/148

(57) ABSTRACT

A just-in-time system. The system includes a trampoline, a method table just corresponding to an executive program, and a linking device. the method table contains plural memory locations. The linking device is used to pre-assign a memory address for store in both a predetermined memory location and the trampoline. Thus, at initialization of the system, the romizing process in the prior art can be simplified without the additional time and labor cost, and the initialization time is saved.

### BACKGROUND OF THE INVENTION

1. Field of the Invention

The invention relates to a just-in-time kilo virtual machine (JIT KVM) system and, more particularly, to a JIT KVM system and the initialization thereof.

2. Description of Related Art

The concept of kilo virtual machine (KVM) is widely used in technical products, such as cellphones, screen phones, car pilot system, PDA . . . etc. The KVM is a software layer operated at the top layer of a master operating system to thus allow application programs, such as communication and Java programs, to be independent of any hardware change at the bottom layer. When the KVM is operated with just-in-time (JIT), a trampoline is used to link all required KVM devices for initialization, which is referred to a romizing process. The romizing process has to determine a memory location linked by the trampoline in compiling. Thus, the memory location and the KVM devices are dynamically linked when a program is executed, wherein the memory location is stored in a method table corresponding to the program. However, such a way wastes additional execution time and lacks of efficiency to a user.

Therefore, it is desirable to provide an improved KVM to mitigate and/or obviate the aforementioned problems.

### SUMMARY OF THE INVENTION

An object of the invention is to provide a just-in-time kilo virtual machine (JIT KVM) system, including a trampoline, a method table just corresponding to an executive program, and a linking device. The method table has plural memory locations. At initialization of the system, a romizing process stores a predetermined memory address in the trampoline. The linking device pre-assigns a memory address for store in both a predetermined memory location of the method table and the trampoline in compiling. Thus, the initialization time is saved since the user does not require taking the additional time to perform the romizing process. In addition, the linking device can change the desired memory location without re-editing the codes.

Another object of the invention is to provide a non-delay initialization process for a just-in-time kilo virtual machine system, including the steps: a source code analyzing step, an encoding step, an object file generating step and a memory location assigning step. The source code analyzing step reads plural sets of source codes of an executive program and analyzes the source codes to thus generate an analysis result. The encoding step encodes the source codes based on the analysis result. The object file generating step generates object codes corresponding to the source codes. The memory location assigning step uses a linking device to pre-assign a memory address for store in both a predetermined memory location of a method table just corresponding to the executive program and a trampoline.

A compiler or assembler is used to encode the executive program to generate the linking device.

Other objects, advantages, and novel features of the invention will become more apparent from the following detailed description when taken in conjunction with the accompanying drawings.

### BRIEF DESCRIPTION OF THE DRAWINGS

FIG. 1 is a diagram of a just-in-time kilo virtual machine system according to the invention; and

FIG. 2 is a flowchart of FIG. 1 according to the invention.

### DETAILED DESCRIPTION OF THE PREFERRED EMBODIMENT

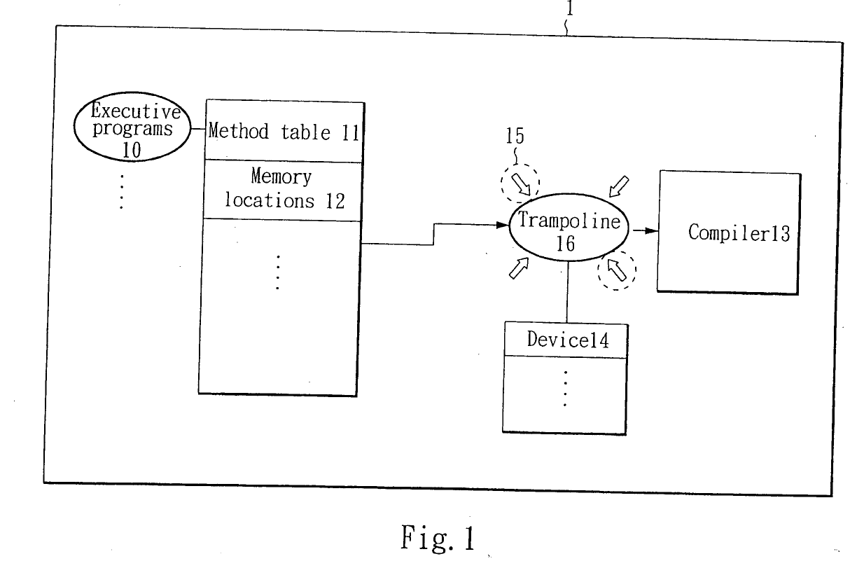

FIG. 1 is a diagram of a just-in-time kilo virtual machine (JIT KVM) system 1 according to the invention. As shown in FIG. 1, the system 1 can be applied to, such as cellphones, screen phones, car pilot system, PDA . . . etc., to thus execute various executive programs 10. The executive programs 10 can be edited by Java language, assembly language and the like, and control, such as, device 14 to execute corresponding operations.

The system 1 further includes a method table 11 just corresponding to the executive programs 10. The method table 11 contains plural memory locations 12 such that when initializing, the system 1 stores the memory locations in a trampoline 16. A compiler 13 is used to generate a linking device 15 and pre-assigns a memory address for store in both a predetermined memory location of the method table 11 and the trampoline 16 in compiling. Thus, at the initialization, the additional time is not required in romizing and further the initialization time is saved.

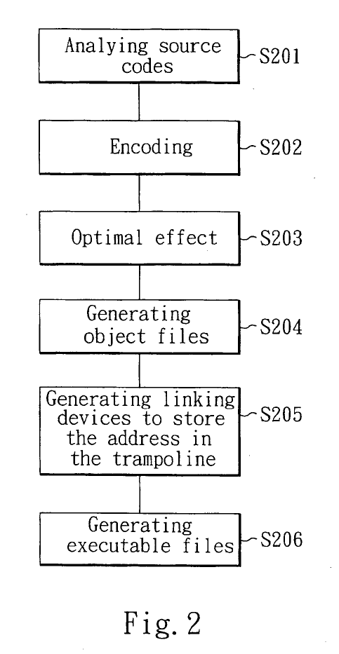

FIG. 2 is a flowchart of FIG. 1 according to the invention. As shown in FIG. 2, the compiler 13 firstly reads source codes of the executive programs for analysis (S201) as cited in a typical compiling step. Next, the compiler 13 is based on the analysis to encode the source codes (S202), i.e., call functions and sub-functions used by partial source codes are integrated into the partial source codes respectively. Next, the compiler 13 dynamically adjusts the source codes' contents and sequences to find an optimal effect (S203). Next, the compiler 13 is based again on the analysis to generate a respective object file (S204). Next, the compiler 13 pre-assigns a memory address for store in the memory location 12 of the method table 11 and generates a linking device 15 to store the address in the trampoline 16 (S205). Finally, the compiler 13 links the linking device 15 and the object file to thus generate an executable file (S206). When the system 10 executes the executable file, the address is no more required writing in the trampoline 16 or the method table 11 since it is assigned in advance, and thus the initialization time is saved. In addition, if the predetermined memory location is to be changed, it can be obtained conveniently by redirecting the linking device without changing the source codes.

Although the present invention has been explained in relation to its preferred embodiment, it is to be understood that many other possible modifications and variations can be made without departing from the spirit and scope of the invention as hereinafter claimed.

What is claimed is:

1. A non-delay initialization process for a just-in-time kilo virtual machine (JIT KVM) system, the system reading a method table corresponding an executive program, the method table containing plural memory locations stored in a trampoline of the system, the process comprising:
a source code analyzing step, which reads plural sets of source codes of the executive program and analyzes the source codes to thus generate an analysis result;
an encoding step, which encodes the source codes of the executive program based on the analysis result;
an object file generating step, which compiles the source codes of the executive program encoded in the encoding step to thus generate an object file; and
a memory location assigning step, which uses a linking device to pre-assign a memory address for store in both a predetermined memory location of the method table and the trampoline and further link the object file to thus generate an executable file.

2. The process as claimed in claim 1, wherein in the memory location assigning step, the linking device is generated by a compiler or assembler.

3. The process as claimed in claim 1, further comprising a romizing step, which dynamically links the memory locations of the method table, the executive program and a device of the system through the trampoline when the executive program is executed.

4. A just-in-time kilo virtual machine system, comprising:
an executive program;
a method table corresponding to the executive program and containing plural memory locations in which a predetermined memory location is assigned to store a memory address;
a trampoline to store the memory locations and the memory address; and
a linking device to pre-assign the memory address for writing in the predetermined memory location assigned.

5. The system as claimed in claim 4, further comprising a compiler to compile the executive program and generate the linking device.

6. The system as claimed in claim 4, further comprising plural devices linked through the trampoline.
